(19) United States
(12) Patent Application Publication
(10) Pub. No.: US 2016/0136799 A1
(43) Pub. Date: May 19, 2016

(54) HAND-HELD ERGONOMIC JACKHAMMER HOLDER FOR CONCRETE FLOOR CHIPPING, JACKHAMMER AND HOLDER ASSEMBLY, AND METHOD OF USE THEREOF

(71) Applicant: RNP INDUSTRIES INC., Boisbriand (CA)

(72) Inventors: Danny MORISSETTE, Boisbriand (CA); Erick SMITH, (US)

(21) Appl. No.: 14/899,474

(22) PCT Filed: Jun. 19, 2014
(86) PCT No.: PCT/CA2014/000509

§ 371 Date: Dec. 17, 2015

Related U.S. Application Data
(60) Provisional application No. 61/840,130, filed on Jun. 27, 2013.

(51) Int. Cl. B25D 17/32; B25D 17/20; B25D 17/04

(52) U.S. Cl. CPC B25D 17/32; B25D 17/043; B25D 17/20

(57) ABSTRACT

A self-adjusting hand-held ergonomic holder for jackhammer for manual use by an operator in chipping a hardened ground surface along a continuously variable chipping strike angle. The holder includes a rigid main frame with an upper load bearing handle and a cradle receiving a pneumatically powered hammer with a reciprocatable elongated pneumatically controlled bit operatively mounted to one end thereof. A coil spring assembly associated with the cradle dampens vibrations generated by the jackhammer. A spring loaded caster member is mounted to the main frame lower portion opposite the jackhammer and providing dynamic continuously variable relative angular chipping tilt of the elongated bit responsive to and acting against the handle bearing load, transversely along the ground surface between a cradle first position, making a generally small acute angle relative to the bearing load downward axis and spaced apart from the caster, and a cradle second position, making a large acute angle relative to the bearing load downward axis and closely proximate the caster.

### CROSS-REFERENCE DATA

This application claims the conventional priority of U.S. Provisional patent application No. 61/840,130 filed on Jun. 27, 2013

### FIELD OF THE INVENTION

The present invention is directed at a jackhammer holder that will enable a worker to perform concrete chipping with a pneumatic power assisted jackhammer, under a single degree of liberty jackhammer bit or point sliding system, while maintaining an upright posture for the worker and minimizing vibration and loads transmission to the worker and musculoskeletal strains sustained by the worker.

### BACKGROUND OF THE INVENTION

Ergonomics is the scientific discipline concerned with the understanding of interactions among humans and other elements of a system, and the profession that applies theory, principles, data and methods to design in order to optimize human well-being and overall system performance. Ergonomics is employed to fulfill the goals of health and safety and productivity. It is relevant in the design of such things as safe furniture and easy-to-use interfaces to machines and equipment. Proper ergonomic design is necessary to prevent repetitive strain injuries and other musculoskeletal disorders, which can develop over time and can lead to long-term disability. Ergonomics is concerned with the “fit” between the user, equipment and their environments. It takes account of the user's capabilities and limitations in seeking to ensure that tasks, functions, information and the environment suit each user.

To assess the fit between a person and the used technology, ergonomists consider the job (activity) being done and the demands on the user; the equipment used (its size, shape, and how appropriate it is for the task), and the information used (how it is presented, accessed, and changed). Ergonomics draws on many disciplines in its study of humans and their environments, including anthropometry, biomechanics, mechanical engineering, industrial engineering, industrial design, information design, kinesiology, physiology, and psychology.

In the 19th century, Frederick Winslow Taylor pioneered the scientific management method, which proposed a way to find the optimum method of carrying out a given task. Taylor found that he could, for example, triple the amount of coal that workers were shoveling by incrementally reducing the size and weight of coal shovels until the fastest shoveling rate was reached. Frank and Lillian Gilbreth expanded Taylor's methods in the early 1900s to develop the time and motion study. They aimed to improve efficiency by eliminating unnecessary steps and actions. By applying this approach, the Gilbreths reduced the number of motions in bricklaying from 18 to 4.5, allowing bricklayers to increase their productivity from 120 to 350 bricks per hour.

Physical ergonomics is concerned with human anatomy, and some of the anthropometric, physiological and bio mechanical characteristics as they relate to physical activity. One of the most prevalent types of work-related injuries is musculoskeletal disorders. Work-related musculoskeletal disorders (WRMDs) result in persistent pain, loss of functional capacity and work disability, but their initial diagnosis is difficult because they are mainly based on complaints of pain and other symptoms. Certain jobs or work conditions cause a higher rate worker complaints of undue strain, localized fatigue, discomfort, or pain that does not go away after overnight rest. These types of jobs are often those involving activities such as repetitive and forceful exertions; frequent, heavy, or overhead lifts; awkward work positions; or use of vibrating equipment. Ergonomics programs can cut workers' compensation costs, increase productivity and decrease employee turnover.

A liability affecting a large proportion of concrete infrastructure, such as bridges, covered parking buildings, and the like, is spalling. Spalling is caused by concrete embedded rebar corrosion, which will create tension loads within the concrete leading to its spalling. To correct these deficiencies, rehabilitation work is needed which requires concrete chipping, to allow the worker to gain access to the rebars for remedial action. Reciprocating action hammers are typically used by workers, who are submitted to considerable musculoskeletal strains, vibrations, and injury hazards. These workers need to handle and push such jack hammers or chipping hammers, which weight usually between 7 and 18 kilograms (kg) and which carry a bit or point having a reciprocating frequency usually ranging between about 700 to 1,600 per minute, in awkward postures conducive to injuries. Vibrations generated by chipping hammers, measured in meter per square second, can lead to industrial injuries such as the Raynaud syndrome, carpal tunnel, white fingers, and the like.

Trolleys can be used for supporting jackhammers during transport whilst not in operation. Such trolleys relieve the operator from some of the physical strains of lifting, holding and moving the jackhammer, but are not designed to assist the operator during ground surface chipping operations.

### SUMMARY OF THE INVENTION

The invention relates to a hand-held ergonomic holder for jackhammer for manual use by an operator in chipping a hardened ground surface along a continuously variable chipping angle, said holder comprising:
a) a rigid main frame defining an upper portion and a lower portion and a front end and rear end;
b) an elongated cradle integral to said main frame front end for receiving and fixedly releasably supporting the jackhammer having an associated reciprocatable bit;
c) bearing means, mounted to said main frame upper portion for supporting a downward load extending along a jackhammer operating axis;
d) caster means, for engagement with the ground surface;
e) means for mounting said caster means to said rear end of main frame lower portion opposite said cradle, and providing dynamic continuously variable relative angular chipping tilt of the jackhammer bit responsive to and acting against said bearing means load, transversely along the ground surface between a cradle first position, making a generally small acute angle relative to said bearing load downward axis and spaced apart from said caster means, and a cradle second position, making a large acute angle relative to said bearing load downward axis and closely proximate said caster means; and
f) biasing means continuously biasing said means for mounting the caster means against said bearing means load, whereby said caster means is biased in a downwardly outwardly divergent stable condition relative to said cradle;
wherein the operator will remain generally upright and in stand still condition during transverse relative angular chipping tilt of the jackhammer bit during chipping operation over the ground surface.

In one embodiment, said bearing means incorporates handle means enabling leveraging the operator's weight to downwardly bias said cradle along the bearing means downward load axis in a non-pushing fashion.

In one embodiment, there is further provided a sliding carrier means integral to said cradle for releasably movably mounting the jackhammer into said cradle in a partly slidable fashion between first and second limit positions along a jackhammer operating axis, and a single-axis vibration dampening means integrally mounted to said sliding carrier means.

In one embodiment, said handle means consists of a first gooseneck handle anchored to said main frame front end upper portion, and a second handle member anchored to said main frame front end lower portion.

Alternately, said handle means could consist of a T-shape frame defining a main leg and a top transverse leg, a pair of opposite one another tubular handles being formed at opposite ends of said top transverse leg, each tubular handle covered with a vibration dampening sleeve.

In one embodiment, a manual trigger means could be carried by said one tubular handle and operatively connected to a controller means controlling reciprocating action of the jackhammer bit concurrently with actuation of said liquid mist generating means and of said brake means.

Said handle means could form a telescopingly extendible handle member, enabling adjustment of said holder to operator's height.

In one embodiment, said means for mounting said caster means consists of: a connecting rod having opposite first end and second end, a pivot mount pivotally interconnecting said rod first end to said rear end of main frame lower portion about a first pivotal axis generally orthogonal to said bearing means downward load, and a yoke member rotatably interconnecting said rod second end to said caster means along a second pivotal axis parallel to said first pivotal axis, said connecting rod movable between a first limit position spaced apart and diverging from said cradle and a second limit position closely proximate the cradle, wherein a large acute angle is formed therebetween.

A releasable self-locking brake means could then be provided, operatively mounted to said caster means and releasably locking same.

In one embodiment, there is further included liquid mist generating means, mounted to said front end of main frame lower portion and generating a liquid mist on the ground surface ahead of said cradle for airborne dust management.

In one embodiment, a support leg could be provided, pivotally mounted with limited play at one end to said main frame upper portion and having another end being ground engageable in divergent fashion relative to said main frame and spacedly opposite from a plane intersecting said caster means connecting rod and said cradle, wherein said support leg creates with said caster means a two point ground support system for providing with the jackhammer bit a three point self standing system on the ground.

Said vibration dampening means could include means locking all degrees of freedom aside from a translational axis parallel to said cradle for absorbing the vibrations caused by the jackhammer bit reciprocating action on ground. For example, said vibration dampening means could consist of a mechanical coil spring means continuously biasing said sliding carrier means towards said first limit position thereof, wherein said first limit position is intermediate said second limit position and said handle means.

In one embodiment, said biasing means is a torsion spring member, interconnecting said connecting rod to said main frame, said connecting rod forming with said main frame a spring loaded lever arm system so that said torsion spring member provides continuous compensation for the weight of the jackhammer in said cradle at all relative angles of said angular chipping tilt of the jackhammer.

The present invention also relates to the combination of such a jackhammer powered by a power source, and of such an ergonomic hand-held holder for jackhammer for manual use by an operator in chipping a hardened ground surface along a continuously variable chipping angle.

In one embodiment, said power source comprises an external compressed air power source operatively interconnected to said jackhammer.

The present invention also relates to a method of use of such a jackhammer and ergonomic holder assembly, comprising the following steps:
a) mounting the jackhammer onto its holder by using a coupling member;
b) positioning the jackhammer bit in register with and against the ground surface to be fractured;
c) actuating the jackhammer reciprocatable bit in reciprocating fashion;
d) locking the caster means;
e) optionally, activating the liquid mist generating means;
f) leveraging the operator's weight to downwardly bias said cradle along the bearing means downward load axis in a non-pushing fashion;
g) sliding the jackhammer bit transversely over a travel sliding path on the ground surface with concurrent variation of the tilting angle of said jackhammer bit responsive to downward load on said bearing means;
h) stopping the jackhammer bit reciprocating motion by release of the manual trigger means; and
i) repeating steps c) to h) for other ground concrete sections to be fractured.

There could be provided the additional step between said steps f) and g) of the operator putting one foot behind the caster means under a start-stop technique to dynamically control the tilt angle of the jackhammer bit during jackhammer bit travel sliding path, to accommodate variable work surface conditions on the ground surface.

There could also be provided the additional step before step a) of providing telescoping means for adjusting the length of said handle means, and adjusting same according to operator's height. In one embodiment, the above-noted steps c), d) and e) are performed substantially simultaneously (e.g. with consecutive steps c) and d) being spaced by a few millisecond (ms), and consecutive steps d) and e) also spaced by a few ms. Also, in step h), the caster means could also in one embodiment be substantially simultaneously unlocked and liquid mist generating means also simultaneously deactivated.

### BRIEF DESCRIPTION OF THE DRAWINGS

FIG. 1 is a perspective view of a jackhammer and holder assembly with a first embodiment of handle means;

FIG. 2 is a side elevational view of the assembly of FIG. 1, and further suggesting how the water mist system operates over the ground ahead of the jackhammer bit;

FIG. 3A is an exploded view of the holder main frame, handle means, vibration mitigating means and cradle from the embodiment of FIG. 1;

FIG. 3B is an enlarged partly broken perspective view of the jackhammer sliding carriage assembly including pillow blocks of FIG. 3A, with the vibration dampening coil springs and cradle removed for clarity of the view;

FIGS. 3C and 3D are views similar to FIG. 3B but with the coil springs and cradle in operative position, and suggesting the sliding play of the carriage plate between the latter's opposite first and second limit positions;

FIGS. 4 to 6 are views similar to FIG. 2 but at a smaller scale and sequentially suggesting the continuously variable tilting capability of the jackhammer assembly during operation by an operator in phantom lines of the jackhammer over a ground surface;

FIG. 7 is an enlarged separate front perspective view of one embodiment of spring-loaded caster member in upright condition and forming part of the jackhammer and holder assembly;

FIG. 7A is a view similar to FIG. 7 but from an opposite rear perspective view and the jackhammer holder being partly exploded to reveal the wheel yoke angular adjustment plate means;

FIG. 7B is a view similar to FIG. 7A but with a jackhammer and water mist nozzle assembly installed on the holder cradle and with the wheel yoke angular adjustment plate means fully assembled;

FIG. 8 is an exploded view of the caster member elements of FIG. 7;

FIG. 8A is a side elevational view of an alternate embodiment of holder supporting a jackhammer according to the invention, with the wheel yoke biasing means being of a gas spring configuration;

FIG. 9 is a top perspective view of the embodiment of jackhammer assembly of FIG. 1, suggesting how the pivotal support leg can be outwardly tilted to provide three point ground self-standing condition to the jackhammer with the jackhammer bit and the caster member;

FIG. 10 is a view similar to FIG. 1 but with the handle member and water and air hoses removed for clarity of the view;

FIG. 11 is an enlarged view of one embodiment of pneumatic and water feed control system forming part of the present jackhammer and holder assembly of FIG. 1;

FIG. 12 is a diagrammatic view of one embodiment of the pneumatic and water feed control system of the present jackhammer and assembly; and

FIG. 13 is a perspective view of a jackhammer and holder assembly with a second embodiment of handle means according to the invention.

### DETAILED DESCRIPTION OF THE INVENTION

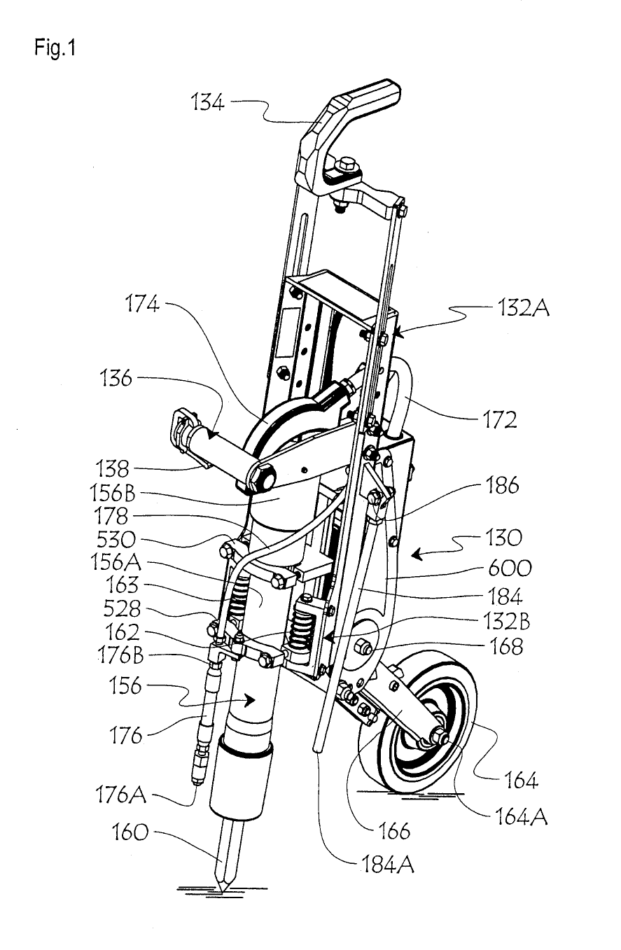

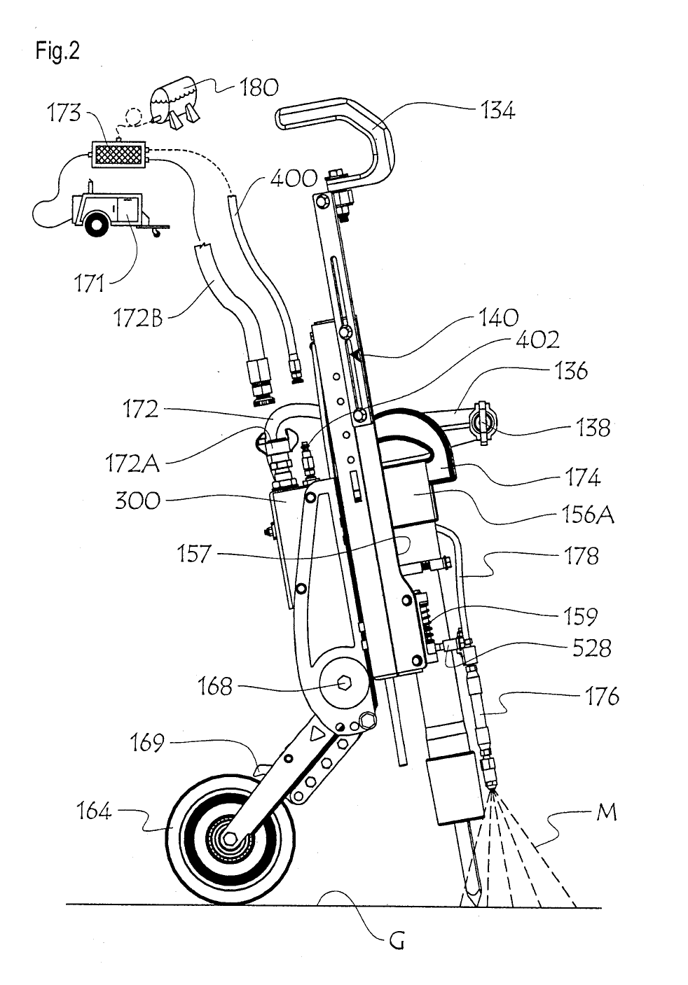

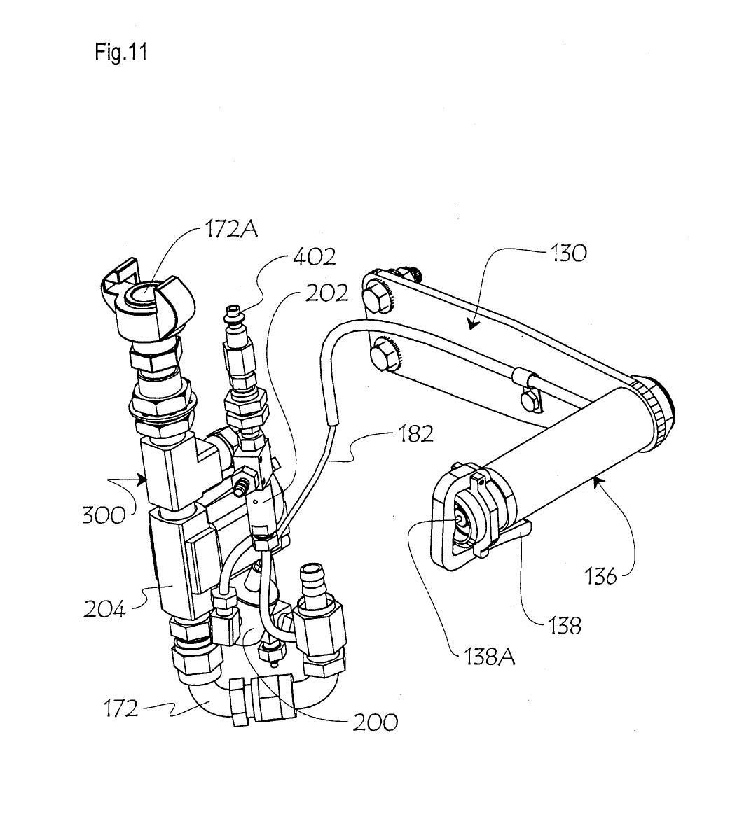

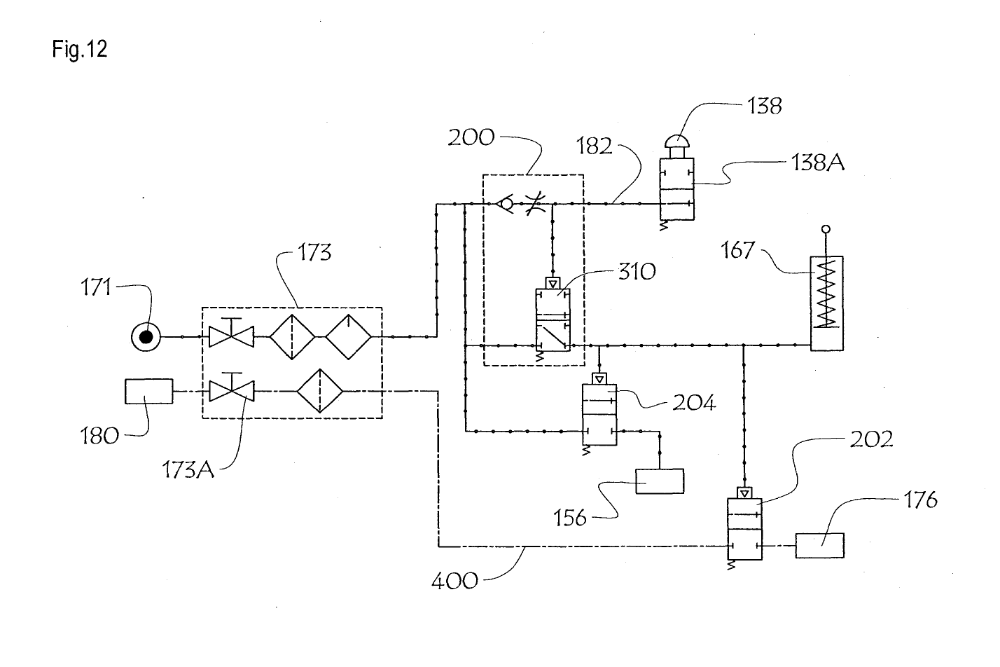

In a first embodiment of the holder main frame assembly 130 according to the invention illustrated in FIG. 1, a top C-shape (for example “gooseneck”) handle 134 is provided and a lower transverse L-shape handle 136 is anchored at one end to an intermediate section of frame 130 intermediate sections 132A and 132B. Lower cylinder handle 136 (see FIGS. 11-12) carries a manual control knob 138 operatively connected by fluid line 182 through master valve 200 and water valve 202, to water line 178 and through master valve 200 and air valve 204, to compressed air hose 172 for on/off valve control thereof.

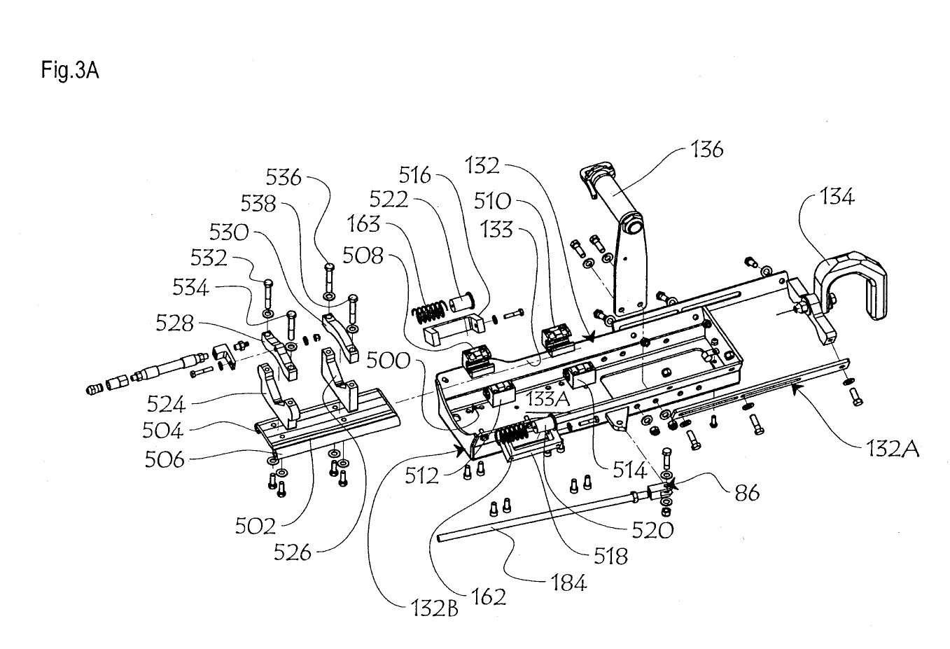

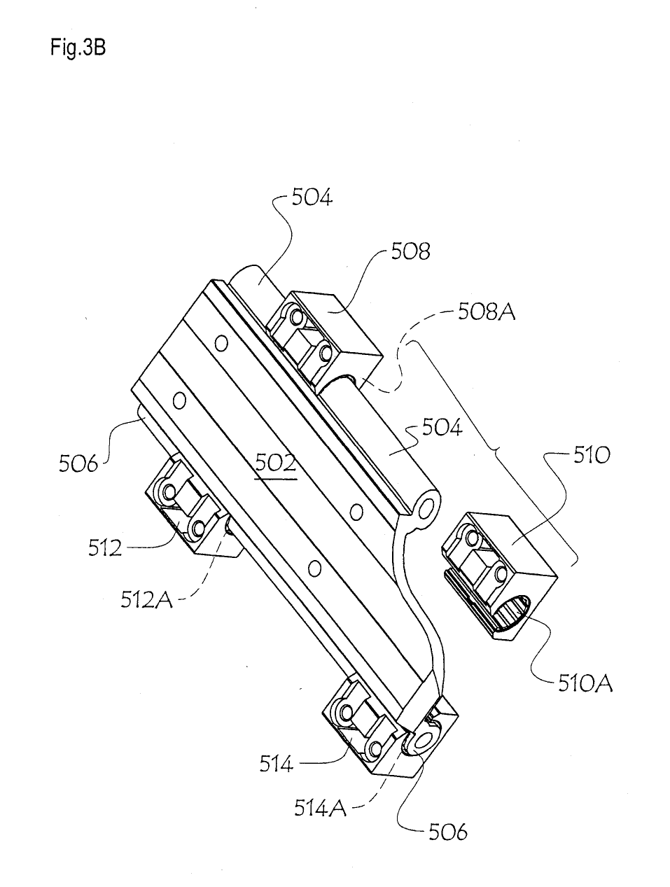

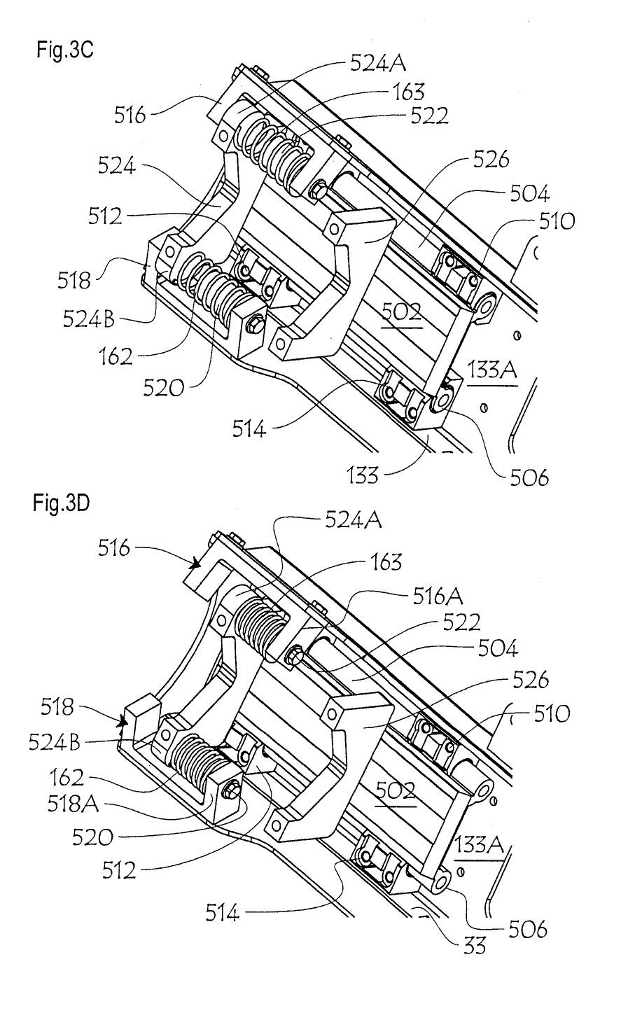

As clearly shown in the sliding carriage assembly of FIGS. 3A-3D of the drawings, holder main frame lower portion 132B includes a peripheral flange 133 forming an open pocket 500. A carriage member 502, e.g. in the shape of a rectangular plate, is mounted inside main frame pocket 500. Carriage plate 502 comprises a pair of opposite edge inwardly elbowed cylindroid flanges 504, 506. Cylindroid flange 504 is slidingly retainingly engaged into complementarily shaped cross-sectionally hemispherically shaped channels 508A, 510A of pillow blocks 508, 510; and cylindroid flange 506 is similarly slidingly retainingly engaged into complementarily shaped cross-sectionally hemispherically shaped channels 512A, 514A, of pillow blocks 512, 514. Pillow blocks 508-514 are anchored to main frame peripheral flange 133 inside pocket 500 adjacent floor 133A of frame 132, and opposite telescopic member 132A.

Carriage plate 502 is thus slidable generally parallel to frame flooring 133A. A pair of C-brackets 516, 518, are anchored to main frame flanges 133, outwardly (i.e. opposite flooring 133A) from pillow blocks 508-514. A short cylindroid bolt 520 engaged by heavy duty coil spring 162 is fixedly mounted to leg 516A of C-bracket 516, and another short cylindroid bolt 522 is engaged by heavy duty coil spring 163 is fixedly mounted to leg 518A of bracket 518. A pair of arcuate cradle clamps 524, 526 are anchored to opposite sections of the outward face of rectangular slider plate 502 so as to be carried therewith.

The opposite end portions 524A, 524B of cradle clamp 524 come in register with bolts 522, 520 respectively, within C-brackets 516, 618 respectively, so that sliding displacement of carriage plate 502 be limited between a retracted first position shown in FIG. 3C wherein bolts 520 and 522 are spaced from arcuate clamp end portions 516, 518, and an extended second position shown in FIG. 3D, where bolts 520, 522 abut against clamp end portions 524B, 524A, respectively. Coil springs 162, 163, continuously bias bolts 520, 522 away from clamp end portions 524B, 524A, to the rest position of FIG. 3C. Cradle clamps 524, 526, are sized and shaped to conformingly adapt to the contour of the main body 156A of jackhammer 156, to receive and support same. As shown in FIG. 3A, an additional pair of outer clamps 528, 530 are provided, releasably taking in sandwich the main body 156A of jackhammer 156 and interlocking with an opposite complementary clamps 524, 526 to releasably lock jackhammer 156 to sliding carrier plate 502 with lock nuts 532, 534, 536, 538. In operation, the reciprocating action of jackhammer bit 160 is accompanied by subdued reciprocating motion of the jackhammer 156 concurrently with associated slider carriage 502 dampened by coil springs 162, 163.

Vibration mitigating means 162, 163 shown in FIGS. 3A-3D thus provides a mechanism that locks all degrees of freedom aside from the translational axis parallel to the chipping action of the jackhammer, and then absorbs the vibrations caused by its reciprocating action, parallel and coplanar with the jackhammer's center line, to eliminate vibrating moments. The vibration mitigating means 162, 163 can be for example mechanical coil springs, pneumatic means, elastomeric means, and others.

Additional similar vibration mitigating means, not illustrated, could be added to the axial handle 134, for improved comfort but however with added weight and bulk for the tool.

The jackhammer 156 has a pneumatic-controlled reciprocatable bit 60 projecting downwardly opposite the handle 134. Vibration dampening means 162, 163, associated with cradle assembly 524-530, give one degree of freedom in the vibration generated axis of jackhammer 156.

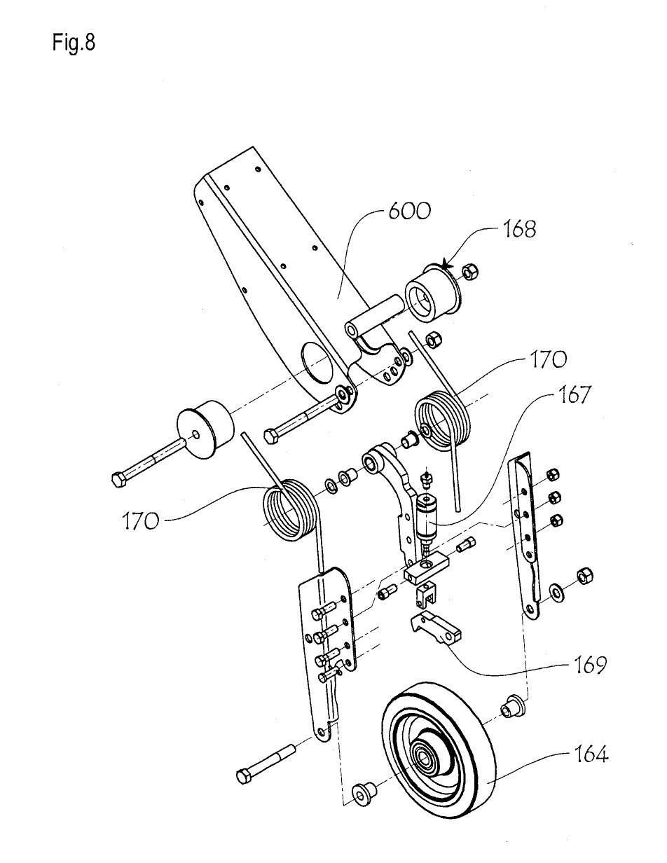

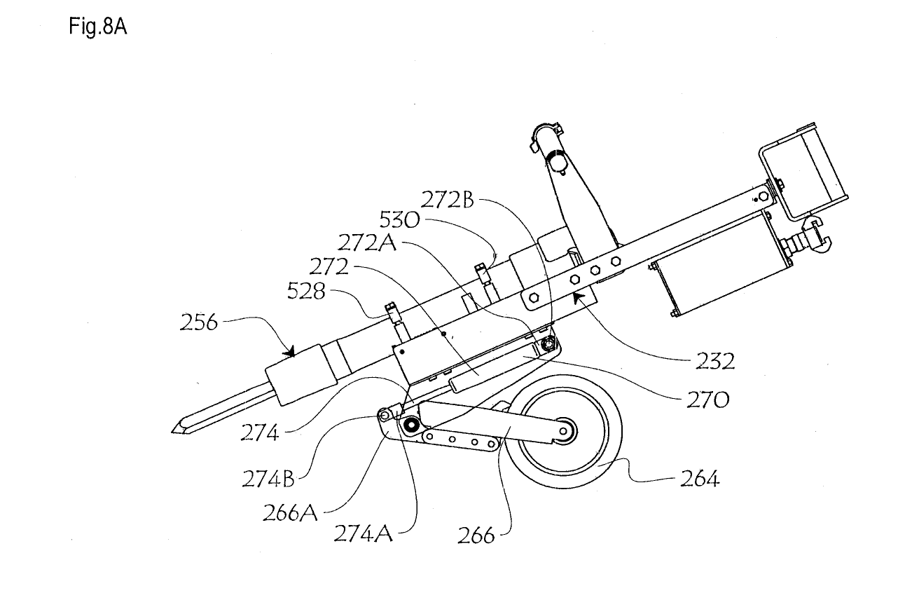

A caster wheel 164 is rotatably mounted at 164A to a lower end of pivotal yoke 166, the latter pivotally carried at top pivot mount 168 opposite wheel 164 to an enlarged frame extension flange 600 of the lower portion 132B of main frame 132. Biasing means such as torsion springs 170 (FIG. 8) biases yoke 166 and associated wheel 164 to diverge downwardly and outwardly relative to cradle assembly 524-530, with the free end tip 160A of jackhammer bit 160 and the lower tangential section of wheel 164 becoming coplanar to the ground surface G to be rehabilitated.

In another embodiment of holder 232 and jackhammer 256 illustrated in FIG. 8A, instead of a mechanical torsion spring biasing means, biasing means consists of a gas spring member 270 made from a cylinder part 272 and a piston rod part 274. The outer end 272A of gas spring cylinder 272 is pivotally carried to holder main frame 232 at pivot mount 272B, while the outer end 274A of piston rod 274 is pivotally mounted at pivot mount 274B to an elbowed inner end ear 266A (FIG. 8A) of yoke 266. In the extended condition of piston rod 274 illustrated in FIG. 8A, yoke 266 is retracted and wheel 264 becomes closely spacedly proximate holder main frame 232, making a small acute angle relative thereto. Moreover, as the piston rod 274 is retracted into its gas spring cylinder 272, yoke 266 and associated wheel 264 pivot away from holder main frame 232 about pivot mount 274B, making a larger acute angle relative to main frame 232.

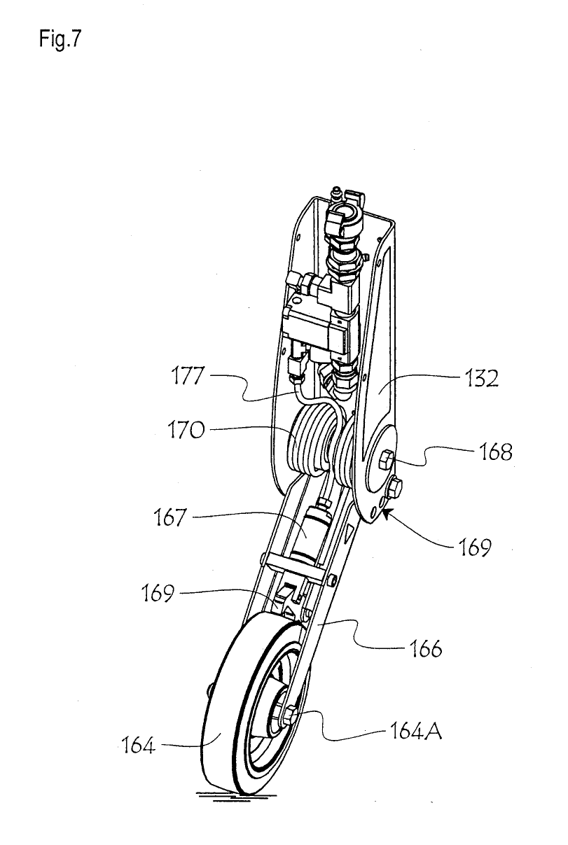

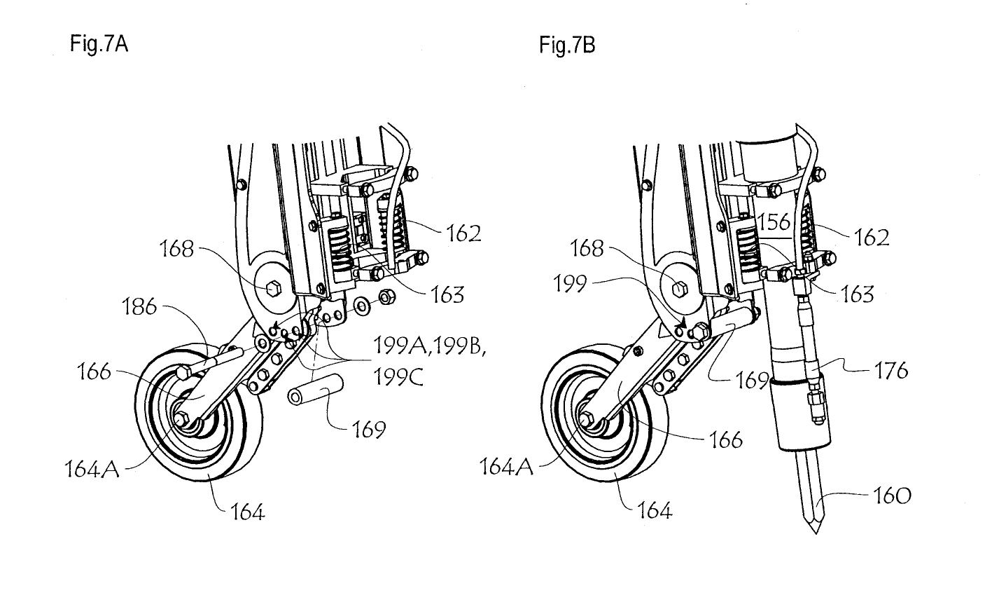

As shown in FIGS. 7 and 11-12, a releasable brake cylinder 167 is mounted in yoke 166, and is provided to caster assembly 164-168 to lock the wheel 164 against rotation. Brake cylinder 167 includes a piston outer end hook 169 frictionally tangentially releasably engageable with wheel 164 for braking same. It is further noted that spring biasing means 170 biases the yoke 166 for rotation about pivot mount 168 towards main frame 130 to compensate for the translational loads sustained by the caster assembly 164-168 during concrete chipping travel of hammer bit 160. Brake cylinder 167 is fed by power line 177 and controlled by valve 310, as detailed later hereinbelow, as well as operatively connected by fluid line 182 through master valve 200 and compressed air supply 172B.

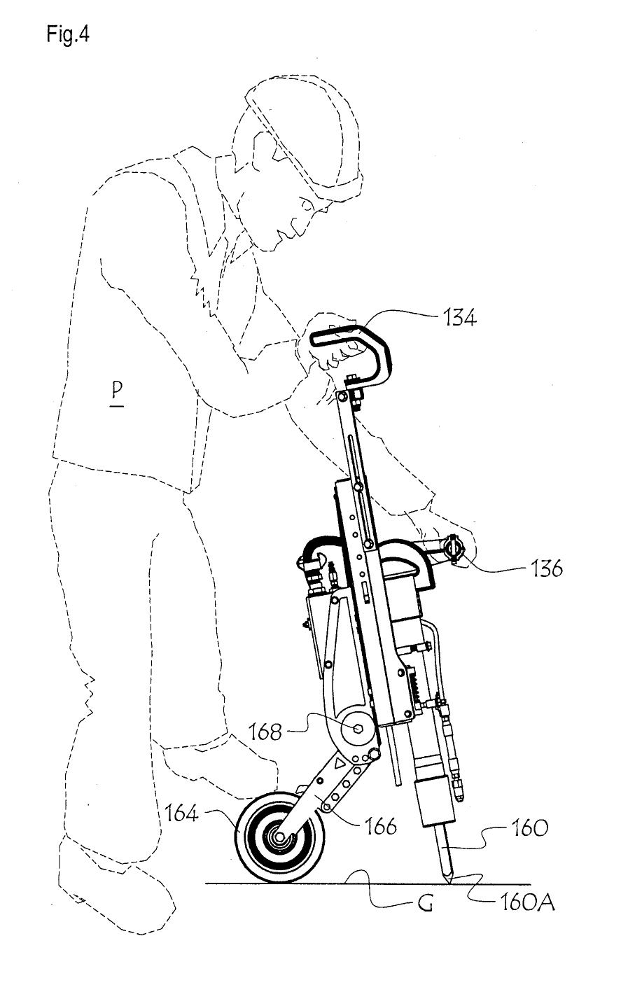

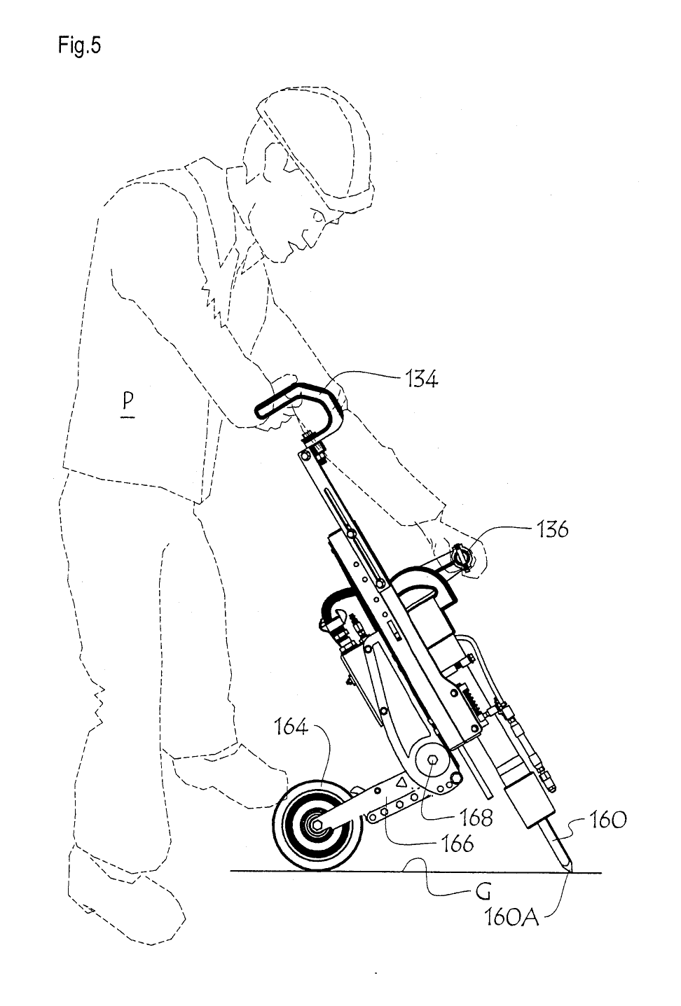

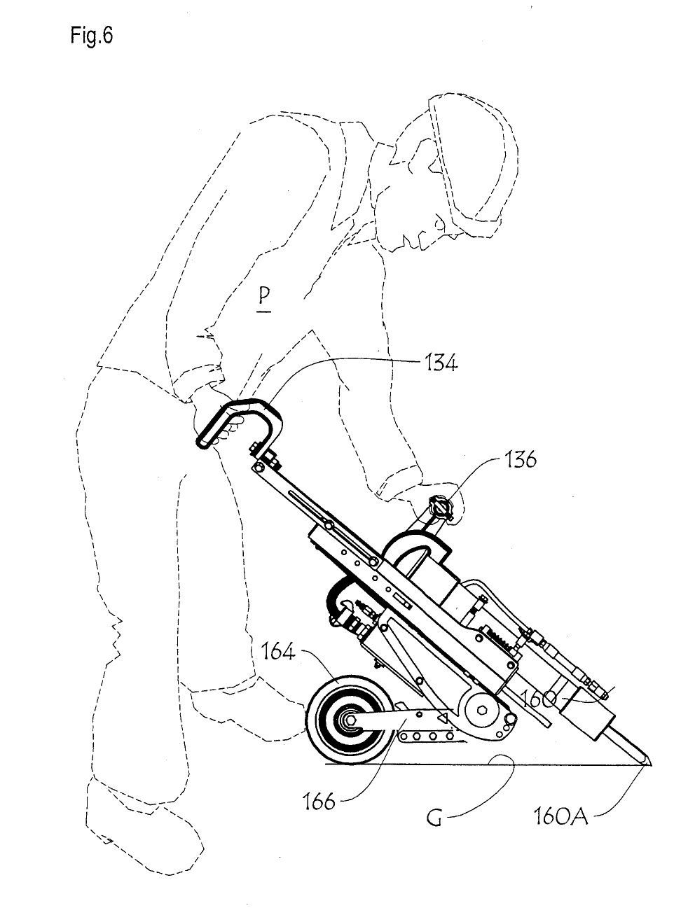

The spring biasing means 170 may be for example a mechanical torsion spring, a traction gas spring, a compression gas spring encapsulated in a drawbar system, a drawbar with traction spring, a cam actuated spring, or others. The spring biasing means 170 of the caster means 164-168 in effect neutralizes the weight of the jackhammer 156 by allowing the user simply to rest in non-pushing fashion on the jackhammer, thus relieving his back from a downward pushing load. The spring loaded leg 166 will continuously compensate for the jackhammer weight, during all variable tilted conditions illustrated sequentially in FIGS. 4 to 6, while the operator P maintains a substantially upright condition.

Coil springs 162, 163, minimize the level of high vibration transmitted from the reciprocating jackhammer 156 to the hands of the operator P (see FIGS. 4-6). The jackhammer bit 160 is reciprocatable under any suitable power source, e.g. a compressed air unit 171 (FIG. 3) fed to air intake port 172A carried by control box 300, via an air hose 172B via a filter and lubricator unit 173.

Having in mind that long term exposure to airborne crystalline silica (e.g. quartz) can cause a disabling, sometimes fatal lung disease known as silicosis, the holder 130 is equipped with an airborne dust management system 176 that releases a water mist ahead of the jackhammer bit 60 to keep the dust to the ground. In one embodiment, mist is activated only when the onboard jackhammer is operating (i.e. the jackhammer bit powered by compressed air and is in reciprocating mode).

During normal chipping operations, the on-board water mist system 176-178 and associated control valve 202 will keep harmful airborne dust to the ground. This system is automatically activated along the hammer's chipping action. The water mist system may be equipped with for example a 22 liters per hour water flow rating. However, a water intake ball valve assembly (173A, see FIG. 12) could be provided in one embodiment in water line 178 to modulate the water flow. The water mist system 176, 178, activates automatically along with the jackhammer's chipping action.

Elongated water nozzle 176 is fixedly mounted to lower clamp 528 along an axis generally parallel to bit 160, but with the nozzle bottom outlet 176A projecting downwardly short of the level of bit 160. The top end 176B of nozzle 176 is operatively coupled to a water line 178 (FIG. 1) fed from an external water supply source 180 via filter unit 173, water supply line 400, water inlet port 402 and control box 300, so that a water mist M may be generated ahead of reciprocating bit 160 on the ground surface G being

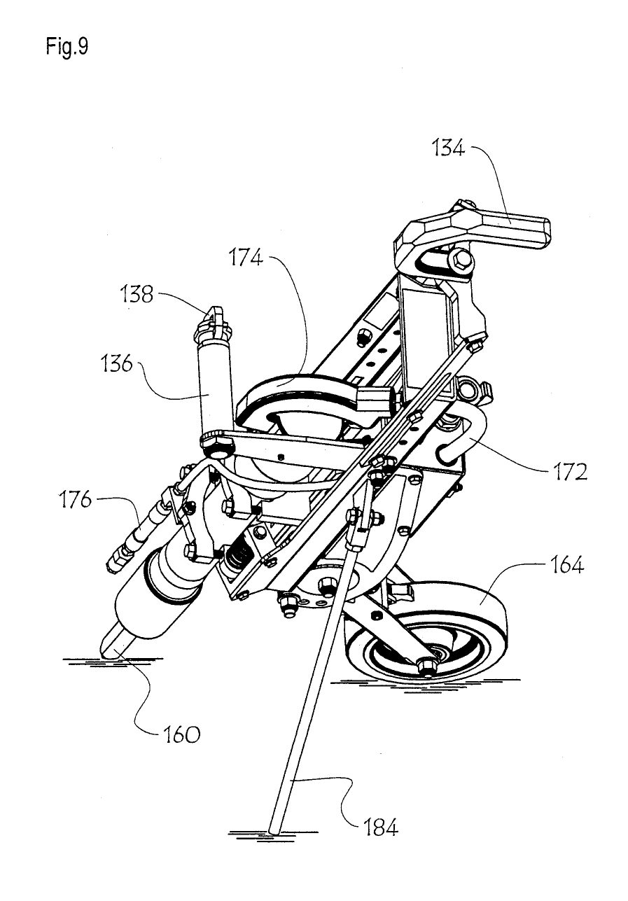

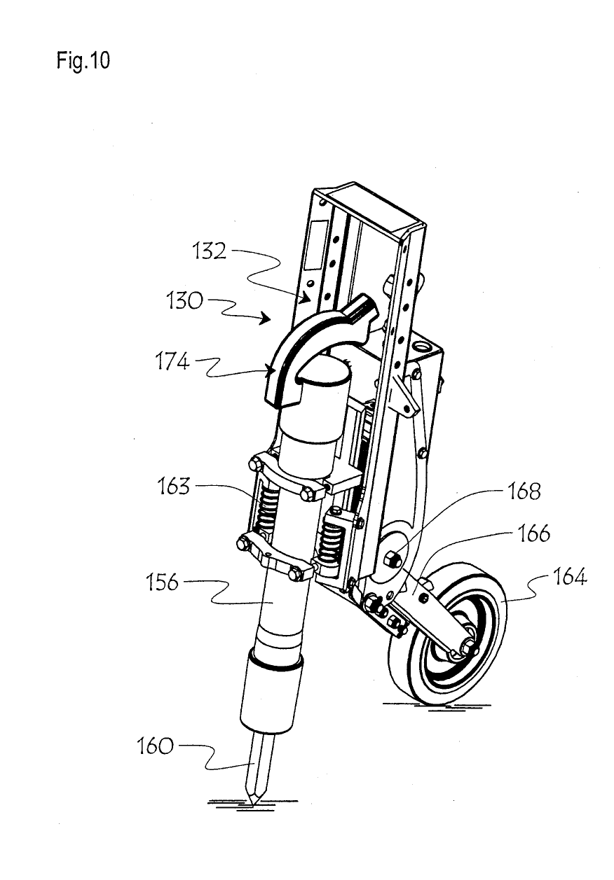

In one embodiment, an elongated leg 184 is pivotally carried with limited play at top end pivot mount 186, to an intermediate portion of holder main frame 132, for movement between a first limit position, abutting against frame 132 (see FIG. 1) to a second limit position (FIG. 9) diverging from frame 132, e.g. by 45 degrees angle relative thereto, in such a way that, after power deactivation of the jackhammer, the bottom end 184A of leg 184 may engage work surface ground G and provide with bit tip 160A and with wheel 164 a three-point self-standing ground support assembly.

The present jackhammer holder has been designed to operate a manual chipping hammer in a natural standing position. Thanks to its support leg 184 and to its automatically locking wheel assembly 164-168, when the operator P bears over the handles 134, 138, this translates this energy, by amplifying and redirecting it into a forward pushing force.

Depending on the type of jackhammer and/or the chipping bit length, it is possible in one embodiment to adjust the angle of the support leg 166 for optimized work performance. For example, a ground clearance ranging from about 6 to 10 centimeters may be used. There may be provided angular adjustment plate means 199 (FIGS. 7A-7B), enabling for example selection of either one of three arcuately spaced plate bore positions 199A, 199B, 199C, to choose from. To change the default position, bolt/nut pivot mount assembly 186 is unscrewed to remove the cylindrical wheel brake stopper 169 to reposition the set in another position selected from one of position bores 199A, 199B, 199C.

In one embodiment, the support leg 166 pivots along a plane generally orthogonal to the plane joining the jackhammer cradle assembly 524-530 and the caster assembly 164-168. Special care should be taken when adjusting the support leg angle. The support leg 166 may be spring loaded in one embodiment.

Thus, during operation of the jackhammer, there is the caster wheel 164 on the ground and the jackhammer bit 160 also on the ground, wherein this two point support allow the jackhammer to be inclined sideways while the jackhammer is pneumatically powered and operating; but when the jackhammer is not operating (compressed air disabled i.e. “off”), the tiltable support leg 184 will provide tripod like stable self-standing condition over ground, if desired.

Aside from the water line 178 required to feed the dust control system, in one embodiment, the controls (trigger 138, brake means 167 and chipping jackhammer 156) run exclusively on compressed air.

It is now understood that the combination of the caster wheel assembly 164-168 and of the spring biasing means 170 enables not only to neutralize the jackhammer weight load for the worker P, but will also allow the worker to bear against the jackhammer holder 130. In this way, thanks to the scissor (lever) shape geometry of the combined jackhammer 156 and its holder 130 and of the braking cylinder brake means 167 of the caster wheel assembly 164-168, the weight of the worker P will be converted, amplified and redirected co-axially to the reciprocating hammering action axis of the jackhammer 156. Moreover, the present invention will enable the travel of the hammer bit 160 forward on the ground work area, while the worker P remains stationary on the concrete, i.e. his two feet F will remain motionless as the jackhammer bit travels along the concrete both horizontally and downwardly into the thickness of the ground concrete to be rehabilitated. A system is therefore created that locks all degrees of freedom of the jackhammer except one, i.e. the axis of the jackhammer chipping action. In order to optimize efficiency and avoid creation of a vibrating moment, the vibration absorbing means are positioned parallel and coplanar with the source of vibration.

It can now be understood that the adaptive scissor (lever) geometry variation, combined with the caster wheel braking system 167, converts amplifies and redirects the bearing load (weight) transferred by the worker P in the coaxial reciprocating hammering axis of the jackhammer 156. The same geometry, when combined with the spring bias means 170 (FIG. 7), provides an uplifting force destined to neutralize the weight of the jackhammer 156.

It is also understood that, when the jackhammer 156 is not in use (i.e. power off for compressed air feed), caster wheel assembly 164-168 may also reduce the efforts needed by the worker P to move the combined jackhammer and its holder 130, from one site to another in a way not unlike that of a wheelbarrow.

In one embodiment, the body of the holder 130 is all made of aluminum to make it lighter and easier to handle. The geometry of holder 130 has been designed to allow for lateral inclination in order to reach areas that would otherwise be reachable only by manual chipping.

As suggested schematically in FIG. 12, it is noted that trigger 138 remotely controls a pneumatic master valve 200 which sends an enable signal that allows a water valve 202 to feed the mist system with the water from water line 178, and a pneumatic valve 204 to activate the jackhammer 156 and lock the wheel 164 with the brake cylinder 167. The water mist system is interlocked with the jackhammer pneumatic activation.

The filter and lubricating unit 173 is provided to minimize jackhammer maintenance downtime. The pneumatic air supply pressure in line 172B may be for example 7 bars. The activation of the jackhammer 156 may be handled by an on-board pneumatic control, wherein one needs to bypass the standard trigger of the jackhammer by taping it down firmly with a sturdy tape, e.g. an electrical or duct tape.

As sequentially suggested in FIGS. 4 to 6 of the drawings, during operation of the jackhammer 156 with the present invention holder 130, the worker P will mostly maintain an upright posture with his spine remaining substantially upright, the two hands of the worker P will grasp and bear over the two overhanging handles 134, 136, while the jackhammer bit 160A and spring loaded caster wheel 164 will bear on the ground in diverging fashion, so that a stable scissor shape jackhammer and holder system remote controlled manually by operator P will emerge.

During operation of the jackhammer 156, worker P may in one configuration of method of use thereof, choose to put one foot behind the caster wheel 164, to maintain the latter in position over the concrete floor, in particular if it is found that the frictional forces between the caster wheel and the ground G is insufficient. The caster wheel brake system 164-168 engages automatically upon start of the jackhammer's reciprocating motion. This jackhammer 156 and its holder 130 system will remain stable during dynamic downward shifting of the center of gravity thereof as the hammer bit 160 travels in one direction forward in the work area inducing fractures while the caster wheel 164 is rolling adaptingly in the same direction along the concrete floor G to be rehabilitated. In effect, the whole weight of the jackhammer will be dynamically neutralized by a lever arm system (from the operator P simply bearing over the handle means without pushing per se with his arms) obtained while the full ground surface chipping is performed with the jackhammer.

In one embodiment, handle means constitutes a bleed type pneumatic actuation system concurrently controlling the pneumatic supply 171 of the jackhammer, the cylinder of braking system 167 of the caster wheel 164 and the supply of water 178 to the water nozzle 176.

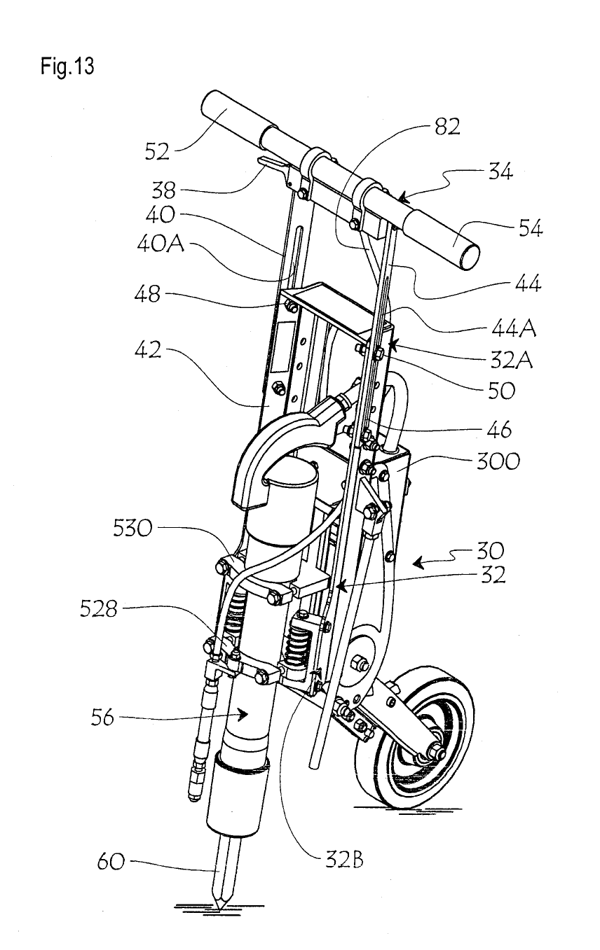

The second embodiment of holder main frame assembly 30 for jackhammer 56 shown in FIG. 13 of the drawings, comprises an elongated open rigid frame 32 provided with an axial T-shape handle means 34 at one upper end end of the elongated frame 32, and defines a bottom end frame portion 32B. Handle means 34 is telescopingly mounted to the upper frame portion 32A of the holder main frame 32 by two pairs of elongated male and female arms 40, 42, and 44, 46, opposite jackhammer bit 60. Male arms 40, 44, each includes an elongated ovoidal slot 40A, 44A, releasably lockingly engaged by lock nuts 48, 50 at a selected extended handle means condition. The opposite coaxial tubular ends of T-shape handle 34 are covered by a pair of coaxial sleeves 52, 54, preferably made from vibration dampening material such as an elastomeric material, thus minimizing the level of high vibrations transmitted from the reciprocating jackhammer 56 to the hands of the operator P. Telescopic means 40-46 are provided to ergonomically adapt the present tool holder 30 to workers of different heights. Other elements of holder 30 remain substantially the same as those of the holder 130 of FIG. 1. Trigger knob 38 is operatively connected to water line 178 (FIGS. 11-12) and to air hose 172 by a control line 82 (182 in the first embodiment) for on/off valve control of water and air flow inside lines 178 and 172, respectively. Trigger knob 38 is also operatively connected to the cylinder brake 167 by power line 177 (FIG. 7).

The invention also relates to a method of use of jackhammer holder with associated jackhammer, comprising the following steps:
1. before operating the present jackhammer 30 (130), the first step may be to adjust the height of the handle means 34 (134, 136) to the height of the operator P, by loosening the corresponding bolts/nuts and slide in or out to the proper height the telescopic slider arms 40, 46 (140, 146), and then retighten firmly the lock bolts/nuts sets. It's also possible to change the position of the front handle 136 further back on the right or left side. The support leg position 84 (184) can be reversed as well.
2. mounting the pneumatic jackhammer 56 onto its holder 130 with the clamps 524-530;
3. connecting the pneumatic air line 172B to the control box air intake 172A;
4. connecting the water supply line 400 to control box water intake 402;
5. positioning the water nozzle 176 closely proximate to the jackhammer bit 160;
6. positioning the jackhammer bit in register with and against the work surface to be fractured;
7. power activating the jackhammer by pressing the control knob 38 (138), and concurrently locking the caster wheel brake 167 and activating said liquid mist generating means;
8. sliding the jackhammer transversely over a travel sliding path on the ground surface;
9. varying the tilting angle of said jackhammer bit responsive to downward load on said bearing means by leveraging the operator's weight to downwardly bias said cradle along the bearing means downward load axis in a non-pushing fashion;
10. reducing the acute angle tilt made by the jackhammer relative to the ground concrete surface to be demolished or chipped, by the worker bearing on the handle means 34 (134, 136);
11. in one embodiment of the method of use of the jackhammer and its holder according to the invention, the worker's foot is put behind the wheel 164, as required accordingly with the level of bearing load applied by the worker on the scissor (lever) shape system, and the local work surface conditions on the ground surface;
12. stopping the jackhammer's bit reciprocating motion by release of the manual trigger switch 38 (138);
13. repeating steps 6 to 12 for other concrete sections to be fractured.

The present jackhammer assembly should always operate in a natural standing position. The compressed air admission 171 should be disconnected before any type of maintenance is performed on the present jackhammer assembly. The present jackhammer assembly is suitable for a wide variety of tools, e.g. for a jackhammer weighting between 7 to 18 Kg. It is made from a rugged structure designed to withstand constant vibrations caused by hammering.

The present hand held jackhammer holder is much more lightweight than prior art jackhammer holders, weighting for example 16 kg (alone, i.e. without the jackhammer per se).

Before proceeding to the actual chipping, in one embodiment, the air and water hoses (172B, 400) may be positioned in a loop fashion. This configuration will allow using the natural rigidity of the main hose 172B, 400 as a spring back mechanism to keep same out of the way of the worker P during operation.

The present jackhammer assembly has been designed to assist the user in ground concrete deck chipping with minimal physical impacts. It absorbs most of the vibrations generated by the pneumatic hammer as well as supporting the entire weight of the jackhammer.

It is noted that when operating the present jackhammer assembly, one should take advantage of the device geometry to perform efficiently while minimizing the operator's efforts. Instead of attempting to manually drive or push the jackhammer into ground concrete to chip it as it would normally be performed manually, when using the present invention, the operator should only bear over using his body weight to generate the pushing force.

It is further noted that in one embodiment, when the trigger 38 (138) located on the handle 34 (134, 136) is held down, the pneumatic jackhammer 56 (156) is activated substantially simultaneously (e.g. within milliseconds) with that of mist of water from nozzle 176 being sprayed on the ground work surface, and also with the caster wheel assembly 164, 168 locking itself with cylinder brake 167; while in an alternate embodiment, this is done sequentially instead of simultaneously.

It is noted that when the wheel 164 locks, it becomes a fixed point in space and the whole body of the jackhammer assembly leverages the weight of the operator P to downwardly bias the hammer's bit forward into the ground work surface. Sometimes, when the wheel 164 locks, it might be slipping back due to the lack of friction caused e.g. by ground dust or water. To assist the locking process, in one embodiment, the user will put his foot (further away from the work zone) behind the wheel 164 to keep it from slipping back. As sequentially suggested in FIGS. 4 to 6, the jackhammer bit moves forward along the ground work surface G, the locked wheel 164 will automatically adapt by rolling as the jackhammer bit tilts.

When the jackhammer assembly 30 (130) is inoperative (compressed air flow is interrupted at the control box), there is no need to lift same for moving same around about the work area. One should instead use the jackhammer bit and the rear wheel 164 as pivots to make it “dance” into the appropriate work position.

1. A hand-held ergonomic holder for jackhammer for manual use by an operator in chipping a hardened ground surface along a continuously variable chipping angle, said holder comprising:
a) a rigid main frame defining an upper portion and a lower portion and a front end and rear end;
b) an elongated cradle integral to said main frame front end for receiving and supporting the jackhammer having an associated reciprocatable bit;
c) bearing means, mounted to said main frame upper portion for supporting a downward load extending along the jackhammer operating axis;
d) caster means, for engagement with the ground surface;
e) means for mounting said caster means to said rear end of main frame lower portion opposite said cradle, and providing dynamic continuously variable relative angular chipping tilt of the jackhammer bit responsive to and acting against said bearing means load, transversely along the ground surface between a cradle first position, making a generally small acute angle relative to said bearing load downward axis and spaced apart from said caster means, and a cradle second position, making a large acute angle relative to said bearing load downward axis and closely proximate said caster means; and
f) biasing means continuously biasing said means for mounting the caster means against said bearing means load, whereby said caster means is biased in a downwardly outwardly divergent stable condition relative to said cradle; wherein the operator will remain generally upright and in stand still condition during transverse relative angular chipping tilt of the jackhammer bit during chipping operation over the ground surface.

2. An ergonomic jackhammer holder as in claim 1,
wherein said bearing means incorporates handle means enabling leveraging the operator's weight to downwardly bias said cradle along the bearing means downward load axis in a non-pushing fashion.

3. An ergonomic jackhammer holder as in claim 2,
further including a sliding carrier means, integral to said cradle for releasably movably mounting the jackhammer into said cradle in a partly slidable fashion between first and second limit positions along a jackhammer operating axis, and a single-axis vibration dampening means, integrally mounted to said sliding carrier means.

4. An ergonomic jackhammer holder as in claim 2,
wherein said handle means consists of a first gooseneck handle anchored to said main frame front end upper portion, and a second handle member anchored to said main frame front end lower portion.

5. An ergonomic jackhammer holder as in claim 2,
wherein said handle means forms a telescopingly extendible handle member, enabling adjustment of said holder to operator's height.

6. An ergonomic jackhammer holder as in claim 2,
wherein said means for mounting said caster means consists of:
a connecting rod having opposite first end and second end,
a pivot mount pivotally interconnecting said rod first end to said rear end of main frame lower portion about a first pivotal axis generally orthogonal to said bearing means downward load, and
a yoke member rotatably interconnecting said rod second end to said caster means along a second pivotal axis parallel to said first pivotal axis, said connecting rod movable between a first limit position spaced apart and diverging from said cradle and a second limit position closely proximate the cradle, wherein a large acute angle is formed therebetween.

7. An ergonomic jackhammer holder as in claim 6,
further including a releasable self-locking brake means, operatively mounted to said caster means and releasably locking same.

8. An ergonomic jackhammer holder as in claim 7,
further including liquid mist generating means, mounted to said front end of main frame lower portion and generating a liquid mist on the ground surface ahead of said cradle for airborne dust management.

9. An ergonomic jackhammer holder as in claim 2,
wherein said handle means consists of a T-shape frame defining a main leg and a top transverse leg, a pair of opposite one and another tubular handles being formed at opposite ends of said top transverse leg, each tubular handle covered with a vibration dampening sleeve.

10. An ergonomic jackhammer holder as in claim 8,
further including a manual trigger means, carried by said one tubular handle and operatively connected to a controller means controlling reciprocating action of the jackhammer bit concurrently with actuation of said liquid mist generating means and of said brake means.

11. An ergonomic jackhammer holder as in claim 6,
further including a support leg, pivotally mounted with limited play at one end to said main frame upper portion and having another end being ground engageable in divergent fashion relative to said main frame and spacedly opposite from a plane intersecting said caster means connecting rod and said cradle, wherein said support leg creates with said caster means a two point ground support system for providing with the jackhammer bit a three point self standing system on the ground.

12. An ergonomic jackhammer holder as in claim 3,
wherein said vibration dampening means includes means locking all degrees of freedom aside from a translational axis parallel to said cradle for absorbing the vibrations caused by the jackhammer bit reciprocating action on ground.

13. An ergonomic jackhammer holder as in claim 12,
wherein said vibration dampening means consists of a mechanical coil spring means, continuously biasing said sliding carrier means towards said first limit position thereof, wherein said first limit position is intermediate said second limit position and said handle means.

14. An ergonomic jackhammer holder as in claim 6,
wherein said biasing means is a torsion spring member, interconnecting said connecting rod to said main frame, said connecting rod forming with said main frame a spring loaded lever arm system so that said torsion spring member provides continuous compensation for the weight of the jackhammer in said cradle at all relative angles of said angular chipping tilt of the jackhammer.

15. In combination, a jackhammer having at one end a reciprocatable bit powered by a power source, and an ergonomic hand-held holder for jackhammer for manual use by an operator in chipping a hardened ground surface along a continuously variable chipping angle, said holder comprising:
a) a rigid main frame defining an upper portion and a lower portion and a front end and rear end;
b) a cradle integral to said main frame front end and fixedly releasably receiving and supporting said jackhammer;
c) bearing means, mounted to said main frame upper portion for supporting a downward load extending along the jackhammer operating axis;
d) caster means, for engagement with the ground surface;
e) means for mounting said caster means to said rear end of main frame lower portion opposite said cradle and providing dynamic continuously variable relative angular chipping tilt of said bit responsive to and acting against said bearing means load, transversely along the ground surface between a first position, making a generally small acute angle relative to said bearing load downward axis and spaced apart from said caster means, and a second position, making a large acute angle relative to said bearing load downward axis and closely proximate said caster means; and
f) biasing means continuously biasing said means for mounting the caster means against said bearing means load, whereby said caster means is biased in a downwardly outwardly divergent stable condition relative to said jackhammer;
wherein the operator will remain generally upright and in stand still condition during said transverse relative angular chipping tilt of said jackhammer bit during chipping operation over the ground surface.

16. The combination as in claim 15,
further including a sliding carrier means integral to said cradle and releasaby movably mounting the jackhammer into said cradle in a partly slidable fashion between first and second limit positions along a jackhammer operating axis, and a single-axis vibration dampening means, integrally mounted to said sliding anchor means and parallel and coplanar with the jackhammer operating axis.

17. The combination as in claim 15,
wherein said power source comprises an external compressed air power source, operatively connected to said jackhammer.

18. The combination as in claim 17,
further including a releasable self-locking brake means, operatively mounted to said caster means and releasably locking same.

19. The combination as in claim 18,
further including liquid mist generating means, mounted to said front end of main frame lower portion and generating a liquid mist on the ground surface ahead of said cradle for airborne dust management.

20. The combination as in claim 19,
further including a manual trigger means, carried by said handle means and operatively connected to a controller means controlling reciprocating action of the jackhammer bit concurrently with actuation of said liquid mist generating means and of said brake means.

21. A method of use of a combination of jackhammer and ergonomic holder of a type as in claim 20, comprising the following steps:
a) mounting the jackhammer onto its holder by using a coupling member;
b) positioning the jackhammer bit in register with and against the ground surface to be fractured;
c) actuating the jackhammer reciprocatable bit in reciprocating fashion;
d) locking the caster means;
e) leveraging the operator's weight to downwardly bias said cradle along the bearing means downward load axis in a non-pushing fashion;
f) sliding the jackhammer bit transversely over a travel sliding path on the ground surface with concurrent variation of the tilting angle of said jackhammer bit responsive to downward load on said bearing means;
g) stopping the jackhammer bit reciprocating motion; and
h) repeating steps b) to g) for other ground concrete sections to be fractured.

22. A method of use as in claim 21,
further including the additional step dd) between said steps d) and e) of:
activating the liquid mist generating means.

23. A method of use as in claim 22,
further including the additional step between said steps e) and f) of the operator putting one foot behind the caster means under a start-stop technique to dynamically control the tilt angle of the jackhammer bit during jackhammer bit travel sliding path so as to accommodate variable work surface conditions on the ground surface.

24. A method of use as in claim 22,
further including the additional step before step a) of providing telescoping means for adjusting the length of said handle means, and adjusting same according to operator's height.

25. A method of use as in claim 22,
wherein said steps c), d) and dd) are performed substantially simultaneously, and wherein in said step g), the caster means is substantially simultaneously unlocked with the liquid mist generating means being also simultaneously deactivated.
